(19) United States
(12) Patent Application Publication
(10) Pub. No.: US 2013/0194789 A1
(43) Pub. Date: Aug. 1, 2013

(54) Lighted Eyeglass Perch and Light Source

(71) Applicant: Juan Vargas, Canyon Country, CA (US)

(72) Inventor: Juan Vargas, Canyon Country, CA (US)

(21) Appl. No.: 13/750,259

(22) Filed: Jan. 25, 2013

Related U.S. Application Data
(60) Provisional application No. 61/591,004, filed on Jan. 26, 2012.

(51) Int. Cl. F21V 33/00

(52) U.S. Cl. CPC F21V 33/0004
USPC 362/183; 362/190

(57) ABSTRACT

Disclosed is a combination night light and eyeglass support having a detachable light source. The device comprises a lighted eyeglass perch supported by a base and an upstanding body portion. Within the upstanding body portion is a hollow region to accept an upright and removable flashlight, which is independently operable from the base and receives battery charging power therethrough. Above the eyeglass perch is a night light that allows the location of the device to be readily recognized in low light situations. Along the base is a lighting control, which operates the night light and the flashlight when attached to the base, providing a light assembly and convenient perch for eyeglass locating in low light.

### CROSS REFERENCE TO RELATED APPLICATION

This application claims the benefit of U.S. Provisional Application No. 61/591,004 filed on Jan. 26, 2011, entitled “Night Vision.” The above identified patent application is herein incorporated by reference in its entirety to provide continuity of disclosure.

### BACKGROUND OF THE INVENTION

1. Field of the Invention

The present invention relates to night lights and eyeglass holders. More specifically, the present invention pertains to a combination night light and eyeglass holder that facilitates locating a pair of eyeglasses at night and providing the user with a removable light source if required in low light conditions.

It is a common occurrence for those who regularly wear eyeglasses to remove the glasses at nighttime prior to bed, where the glasses are generally placed on a bedside table or other counter space adjacent to or in proximity to the wearer's bed. During the night or early morning hours, some users may require their glasses to navigate through their home or to the restroom. For those situations, it is common that the low lighting and the reduced vision of the user can make the retrieval of eyeglasses difficult, particularly if the glasses are not placed in the expected location or if it is an extremely dark environment. The user must then choose to navigate the home with reduced vision while trying to avoid injury, or grasp wildly at the night stand, exposing the eyeglasses and other articles to be damaged or fall from the nightstand surface.

Another situation of interest for individuals and homeowners is the occurrence of an emergency situation during the night. If there is such an emergency, a disoriented individual may find it even more difficult in a tense and chaotic atmosphere to locate their eyeglasses in the dark. If the electricity were to cease because of a storm or downed power line, an individual may not have an accessible flashlight available in order to navigate through the house during the emergency. Purchasing and then locating a separate flashlight near at a user's bedside is not always contemplated until the event occurs where the flashlight becomes a necessity. The present invention is intended to address these concerns by providing a combination eyeglass support or stand, a nightlight, a bedside light and finally an operable removable and handheld light for use around the home in low light.

The present invention is a nightstand eyeglass support that combines several functions that are commonly required in low light environments and during times of activity requiring the user to get out of bed in the night. These functions include a nightlight and general bedside light, an eyeglass perch and means of locating the perch, and finally a removable flashlight for use around the house when normal lighting is not desired or operable. It is submitted that there exists a need in the art for such a device, where users having reduced vision or common nighttime awakenings are accommodated, preventing injury due to tripping or running into objects within the house because of low light conditions.

2. Description of the Prior Art

Devices have been disclosed in the prior art that relate to eyeglass supports and lighting means. These include devices that have been patented and published in patent application publications, and generally relate to accessories for eyeglasses and eyeglass support devices. These devices fail to contemplate a removable lighting feature and structure of the present invention. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 5,979,849 to Williams discloses an eyeglass cleaning station that provides an eyeglass frame support via a plurality of clips, a supply of tissue for wiping the eyeglass lenses, and a holder for cleaning solution. The device has a body structure that supports the eyeglass frame in a position that facilitates ready dispensing of the cleaning solution onto the eyeglass lenses and access to cleaning tissue in proximity thereto. The operation of cleaning can be conducted with a single hand, reducing necessary steps and increasing the potential user base for the Williams device. While providing a novel means of supporting eyeglasses in a position to be cleaned, and further for supporting cleaning elements, the Williams device fails to contemplate the ability to locate the eyeglasses in dim light, and further for providing a removable light source as described by the present invention.

U.S. Pat. No. 6,561,672 to Lessard discloses a sound activated illuminating article holder for locating objects in the dark. The device comprises a body portion, an illumination means and a sound sensor. The body portion includes a holder having a cavity that supports one or a plurality of upstanding articles, while the base of the body portion houses the sound sensor, operational electronics and light sources. The volume required for activation can be set, wherein the user may make an audible sound over the defined threshold to illuminate the device, making the location of articles such as eyeglasses and tissues possible in the dark. The Lessard device contemplates a device for locating objects in the night, wherein the light is sound activated. The present invention provides a constant night light and removable hand light upon request, while also providing a perch for a user's eyeglasses. Therefore location of the eyeglasses in the dark and further navigation within a dark room is possible after retrieving the removable light.

U.S. Pat. No. 5,842,772 to Stern discloses an illuminated eyeglass assembly for use reading in low light. The device comprises a handle portion attaching to the frame of an eyeglass assembly, along with an illumination means along the upper portion of the handle. The handle comprises a hollow, cylindrical assembly that houses a light assembly, battery and switch, while further providing connection for a portion of an outwardly extending eyeglass frame. The Stern device, while disclosing a novel nighttime reading device, is not intended as an eyeglass holder and nightlight. The eyeglasses of Stern are not separable from the handle, nor are they intended to be so. The present invention provides an eyeglass perch for placement of a user's glasses, whereafter they can be retrieved in the dark by way of the illuminated portions of the support assembly attached to the eyeglass perch.

Further, U.S. Pat. No. 6,102,346 to Visser discloses an eyeglass holder comprising of a frame that supports the bridge and temple portions of an eyeglass such that the eyeglasses are positioned in a horizontal position and easily placed or removed on the support frame. The frame comprises a general C-shape having a first and second extended arm positioned apart from one another and connected by a central portion. The arms support the temple portions of the eyeglasses, while the central portion supports the eyeglass bridge. Notches in the frame prevent eyeglass movement of these elements, while a frame-securing suction cup allows the assembly to be mounted against a wall or vertical surface. The Visser device, while providing an efficient and convenient means of storing eyeglass, provides no means of locating the glasses in the dark. The present invention provides an eyeglass perch that supports the bridge of the eyeglasses, but further provides a means to locate the stowed eyeglasses in low light.

Finally, U.S. Pat. Nos. 4,584,633 and 4,722,038 both to Comfort discloses an eyeglass holder for bedside use that comprises an eyeglass cradle or holder means that is connected to a night light and electrical connections to operate the night light in a particular fashion when the device is plugged in and when the eyeglasses are placed within the cradle. A pair of switches determines whether a night light along the holder is illuminated or power is delivered to a third party device plugged into an outlet along the side of the holder. Both a normally closed switch opens, and a normally open switch closes, in response to the weight of a pair of eyeglasses being placed within the holder. When removed, power is fed to a third party lamp or reading light, while after placement of the eyeglasses into the holder, power is cut to the lamp and a night light illuminates for later locating the eyeglasses in the dark. While disclosing a novel electrical device that is responsive to user input, the Comfort devices fail to disclose the novel elements of the present invention, which includes an eyeglass perch, locating night light and a removable auxiliary light for use within a dark environment.

The present invention provides a structure that supports a pair of eyeglasses in a readily graspable position while highlighting their location at night, along with a structure that supports a removable flashlight that operates as a standard bedside light while attached to the base structure. It is submitted that the present invention structure and intent substantially diverges in design elements from the prior art, and consequently it is clear that there is a need in the art for an improvement to existing bedside eyeglass support devices. In this regard the instant invention substantially fulfills these needs.

### SUMMARY OF THE INVENTION

In view of the foregoing disadvantages inherent in the known types of eyeglass stands and lighted assemblies now present in the prior art, the present invention provides a new combination eyeglass and nightlight stand, wherein the same can be utilized for providing convenience for the user when locating one's eyeglasses, utilizing the device as a nightlight or bedside light, and finally for accessing a removable light source in low light.

It is therefore an object of the present invention to provide a new and improved lighted eyeglass support device that has all of the advantages of the prior art and none of the disadvantages.

It is another object of the present invention to provide a lighted eyeglass support device that supports a user's eyeglasses in a horizontal position, whereby access to the eyeglasses is facilitated by the temple region of the glasses and support is provided by a bridge perch.

Another object of the present invention is to provide a lighted eyeglass support device that provides a nightlight for locating the device in low light and for lightly illuminating a room in low light conditions.

Yet another object of the present invention is to provide a lighted eyeglass support device that provides a removable flashlight that provides an operable bedside lamp while attached to the present device and an independent light source when detached.

A final object of the present invention is to provide a lighted eyeglass support device that combines functions of an eyeglass support, nightlight, bedside light and emergency handheld flashlight into a single assembly.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2 shows a side view of the present invention.

FIG. 3 shows a rear perspective view of the present invention whereby the removable light source is detached from the base.

FIG. 4 shows a perspective view of the present invention in a working state, supporting a pair of eyeglasses in a horizontal configuration.

### DETAILED DESCRIPTION OF THE INVENTION

Reference is made herein to the attached drawings. Like reference numerals are used throughout the drawings to depict like or similar elements of the lighted eyeglass support. For the purposes of presenting a brief and clear description of the present invention, the preferred embodiment will be discussed as used for supporting eyeglasses, providing a nightlight and further for providing an independent light source detachable from a base structure. The figures are intended for representative purposes only and should not be considered to be limiting in any respect.

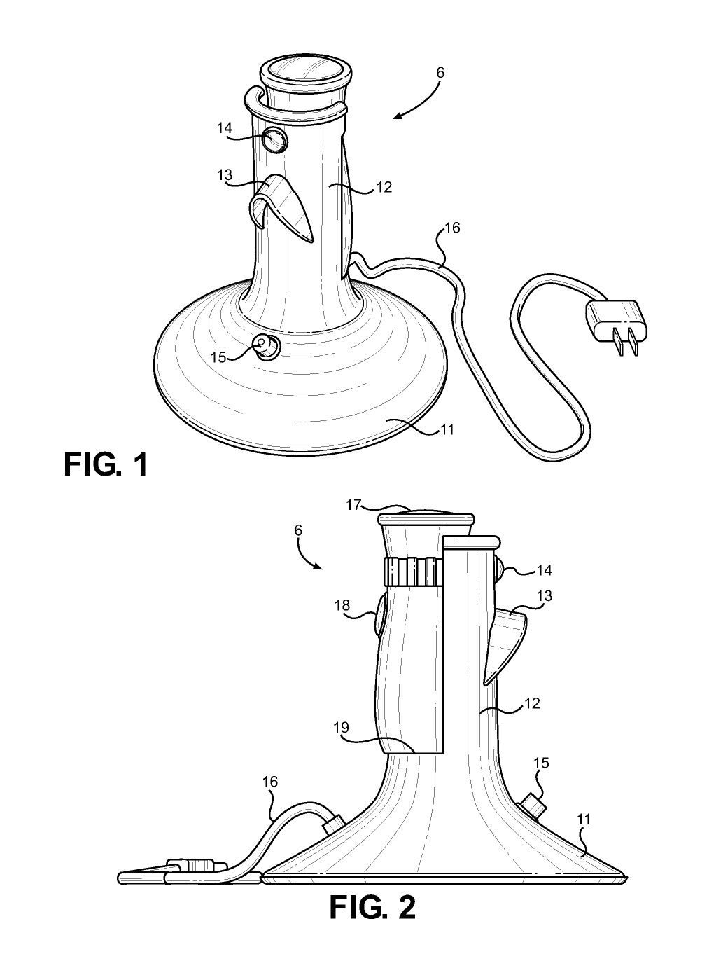

Referring now to FIG. 1, there is shown a perspective view of the eyeglass support structure and light assembly of the present invention. The device comprises support stand having a base 11 and an upstanding region 12. An eyeglass bridge perch 13 is positioned along the upstanding region 12 along the forward section thereof, while the backside of the upstanding region 12 includes a cavity for accepting a removable flashlight assembly 6. The flashlight assembly 6 provides an operable nightstand light projecting upwards while attached to the stand and a handheld light device when detached and operating on battery power. A user switch 15 along the base 11 of the stand allows a user to cycle through the lighting options of the assembly, including operation of a nightlight 14, operation of the upstanding flashlight 6 while thereattached, or ceasing power to both light sources. The nightlight 14 is a soft light that shows the location of the assembly, and therefore the location of an attached pair of eyeglasses that may be supported by the eyeglass perch 13. This allows a user to identify the location of his or her eyeglasses at night and further for locating the flashlight light source in emergency situations.

Power is fed to the light sources through a power cord 16 that attaches to a standard wall outlet. The cord connection powers the nightlight and the flashlight when attached to the stand, and further charges the flashlight batteries while thereattached. Once removed, the flashlight operates as any normal battery-operated flashlight would be expected to operate in the art, with a battery power source and operational controls for illumination.

Referring now to FIG. 2, there is shown a side view of the present invention, wherein the flashlight assembly 6 is connected to the base for receiving power and operating as a standard bedside lamp, projecting light upwards on demand 15. From this orientation, the structure of the stand upstanding region 12 is visualized, whereby its rear portion is removed to allow access for the flashlight assembly 6. The flashlight rests upon a ledge 19 within the rear portion, while the upstanding portion of the stand supports the flashlight in an upright configuration. The nightlight 14 is adapted to be positioned above the eyeglass perch 13 to illuminate downward on its position, while the base 11 includes internal wiring for the user switch 15 and the rear power cord 16. When disconnected, the flashlight assembly 6 is operated by the user, whereby an on/off button 18 controls battery power delivery to a light source within the forward portion 17 of the flashlight for illumination purposes.

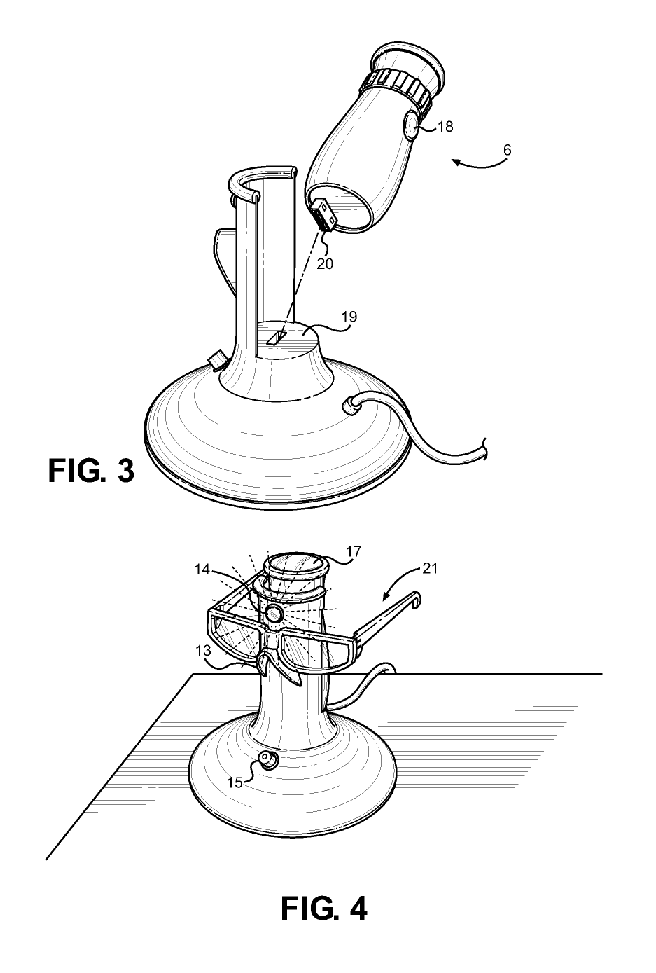

Referring now to FIG. 3, there is shown a rear perspective view of the present invention, wherein the flashlight assembly 6 is being detached from the base stand for independent use thereof. When desired, the flashlight 6 is detached from the upper portion of the stand, disconnecting electrical connectivity between the two assemblies for separate use. Along the ledge 19 of the upper portion is an electrical receptacle adapted to accept an electrical prong or connector 20 at the base of the flashlight 6. This connector allows outlet power from the stand to flow to the flashlight, powering the light while attached and further charging the batteries within the flashlight. When attached, operation of the flashlight is controlled by the user switch along the base of the stand, and when detached the flashlight control switch 18 is operable for controlling outward illumination.

Referring now to FIG. 4, there is shown a perspective view of the eyeglass stand of the present invention in a working state, supporting a pair of eyeglasses in a horizontal configuration for a user to identify their location and easily retrieve the glasses when desired. As shown, the eyeglasses 21 are supported by their bridge such that the eyeglass temples can be extended and positioned on opposing sides of the stand upstanding portion. When a user places the glasses 21 in this position before retiring to bed, the switch 15 can be depressed to activate either the upstanding light 17 of the flashlight assembly or the nightlight 14 positioned above the eyeglass perch, thereby providing a bedside light or a nightlight and means of locating the user's eyeglasses at night when necessary.

The present invention comprises a bedside lamp having a perch for supporting a pair of eyeglasses. A nightlight illuminates the glasses, permitting a user to quickly find his or her eyeglasses in the dark, while the stand additionally includes an attachment for a removable flashlight that is also operable as a bedside light when attached to the base. When detached, the flashlight can be used for navigating dark areas of a home in an emergency situation or power outage in the night. The present invention allows individuals to quickly and easily locate their glasses and a further source of light while in the dark and during emergency situations. The perch of the eyeglasses may be desired to support only the bridge of a pair of eyeglasses, whereby the temples of the eyeglasses are positioned in an extended position, or alternatively the perch may be designed to accept a collapsed pair of eyeglasses. In the alternative configuration, the perch supports both the bridge and temple region of the glasses such that the eyeglasses can be supported in a collapsed state for reduced footprint.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A lighted eyeglass support device, comprising:
a stand having a base and an upstanding portion, said upstanding portion having a forward and rear portion;
said upstanding portion forward portion having an eyeglass perch and a nightlight thereon;
said upstanding portion rear portion having a cavity at accept a removable flashlight.

2) The device of claim 1, further comprising a user switch for activating said night light.

3) The device of claim 1, wherein:
said flashlight further comprises an electrical connectivity means to achieve electrical connectivity with said stand when positioned within said upstanding portion;
said electrical connectivity providing control of said flashlight illumination while thereattached.

4) The device of claim 1, wherein:
said flashlight further comprises an electrical connectivity means to achieve electrical connectivity with said stand when positioned within said upstanding portion;
said electrical connectivity adapted for charging of said flashlight internal battery power supply.

5) The device of claim 1, wherein said eyeglass perch supports the bridge of a pair of eyeglasses.

6) The device of claim 1, wherein said eyeglass perch supports the bridge and temple portions of a pair of eyeglasses.

7) The device of claim 1, wherein said flashlight is independently operable from said stand when detached.
